(19) United States
(12) Patent Application Publication
(10) Pub. No.: US 2005/0273341 A1
(43) Pub. Date: Dec. 8, 2005

(54) Method and device for optimizing the order of assignment of a number of supplies to a number of demanders

(75) Inventor: Klaus Hoffesommer, Lichtenfels (DE)

Correspondence Address: CASELLA & HESPOS, 274 MADISON AVENUE, NEW YORK, NY, 10016, US

(73) Assignee: Optimization Methods Deutschiand Gmbh, Gemunden (DE)

(21) Appl. No.: 10/510,353

(22) PCT Filed: Apr. 4, 2003
(86) PCT No.: PCT/EP03/03551

§ 371 Date: Jun. 23, 2005

Related U.S. Application Data
(60) Provisional application No. 60/370,608, filed on Apr. 5, 2002.

(51) Int. Cl. G06F 17/60

(52) U.S. Cl. 705/1

(57) ABSTRACT

An inventive device for determining an optimized assignment of a number of supplies or resources, such as computer processor units, each having a certain supply amount or resource amount, such as a processing capacity, to a number of demanders or demands, such as tasks to be processed by the computer processor units, each having a certain demand amount to be satisfied by said supplies or resources, such as a capacity demand, i.e. a processing capacity necessary to process the task, in which, after the assignment, the sum of unsatisfied demand amounts is minimized.

The present invention relates to a method and a device for optimizing the order of assignment of a number of supplies or resources, such as transmission lines providing transmission capacity for a number of senders, processor units providing processing capacity for a number of tasks to be processed, or collateral securities for balancing loan accounts, to a number of demanders or demands, such as senders requesting transmission capacity, tasks requesting processing capacity, or loans which are to be balanced by collateral securities, where each supply or resource has a certain supply amount, such as a transmission capacity, a processing capacity; or a security value, and each demander or demand has a certain demand amount, such as a data rate to be transmitted through transmission lines, a capacity demand of a task, i.e. the capacity needed for processing the task, or a loan value, which is to be satisfied by supplies. The present invention further relates to a computer program product comprising instructions which, when loaded, cause a computer to perform the inventive method, and to a storage medium comprising stored data representing said computer program product.

In technical processes, as well as in commercial processes, it is sometimes necessary to find an optimal distribution of supply amounts of a number of supplies over a number of demanders each having a certain demand amount. In many cases, there are restrictions such that not every supply may be used to satisfy a certain demander. E.g. in the case of a distribution of computer tasks to be processed over a plurality of computer processors (e.g. of a computer form), the plurality of computer tasks must be assigned in part or totally to one ore more processors. Moreover, in a transmission network, a number of senders each sending data with a certain data rate should be assigned to a number of transmission lines each having a certain transmission rate such that a maximum data rate can be sent trough the transmission lines. As an example for a commercial process, one may consider balancing loan accounts with collateral securities. The distribution of the supply amounts over the demanders shall be optimized such that, when a total demand amount is the sum of all demand amounts, only a minimum total demand amount remains unsatisfied after the supply amounts are distributed, e.g. a minimum processing demand of tasks to be processed by a computer remains unsatisfied, a data rate which cannot be matched by the transmission rate is minimized, or a loan value which cannot be offset against collateral securities is minimized). The optimal distribution can be represented by an optimized order in distributing the supply amounts over the demanders.

As an example, consider the process of balancing loan accounts with collateral securities. In such a process, a number of loan accounts shall be balanced with a number of collateral securities. A loan account would then represent a demander or demand and the corresponding loan value, i.e. the amount of credit, would represent the demand amount. Further, a collateral security would represent a supply or resource and the corresponding security value would represent the supply amount.

If each collateral security has to be assigned to distinct loan accounts and if the loan accounts have to be balanced in an order that should be determined, then the amount of unsecured total credit may vary significantly depending on that order.

Example: let L₁, L₂, . . . L₅ be five loan accounts. And let S₁, S₂, . . . S₄ be collateral securities allocated to the loan accounts as indicated in FIG. 1.

FIG. 1 shows that each of these four securities are assigned to distinct loan accounts. If we would offset the securities against the loan accounts in the following order

L₁-S₁, L₂-S₁, L₂-S₂, L₃-S₃ L₃-S₄

(no further loan account can be balanced)

then on the one hand a total amount of 1 million $ would remain unsecured (total share of “blank” credit)- and on the other hand 0.9 million $ of security value could not be offset against the assigned loan accounts. But if the securities are offset in an optimized order, for example:

L₅-S₁, L₄-S₄, L₃-S₃, L₃-S₁, L₂-S₂. L₂-S₁, L₁-S₁

the total amount of unsecured credit would be minimized (0.1 million $)

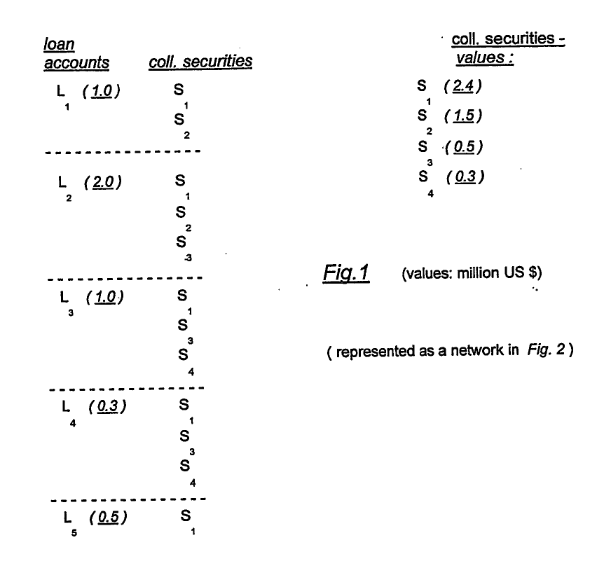

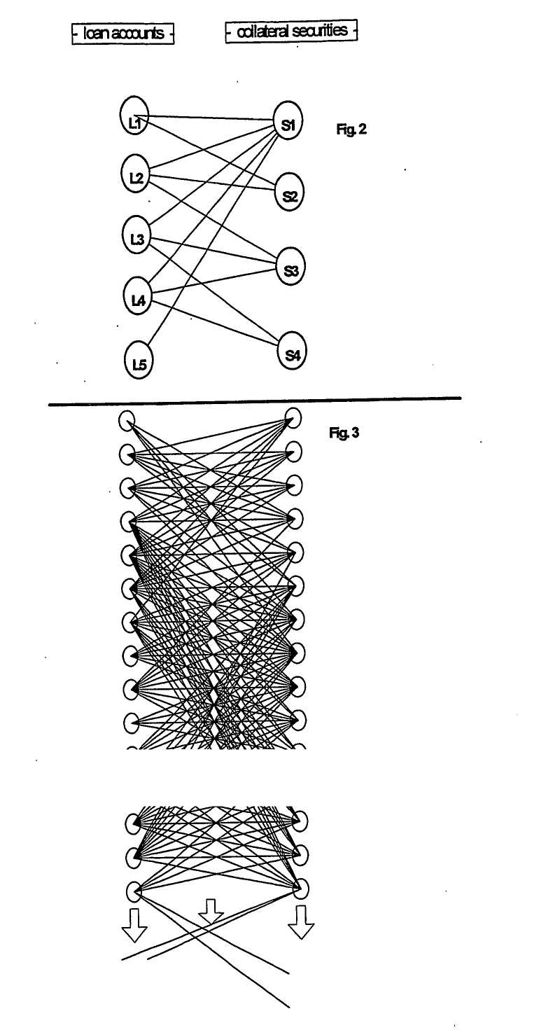

FIG. 2 represents the above assignments as a network. Small networks like this one may easily be optimized without a computer program. But when managing collateralized loans of commercial enterprises the related networks often consist of several hundred (and sometimes several thousand) assignments. Here the order in which these securities are to be offset against the assigned loan accounts can only be optimized by a computer program. FIG. 3 gives an idea of a network related to collaterlized loans of a commercial enterprise.

As a further example, consider a data transmission system or network, which includes senders sending data with a certain data rate and transmission lines being able to transmit data by a certain transmission rate. Each sender may be connected to certain ones of the transmission lines, and each transmission line may be connected to a certain number of senders. In this example, the senders may be seen as demanders or demands and the transmission lines as the supplies or resources. Further, the data rate may be seen as the demand amount and the transmission rate as the supply amount. In order to optimize the data transfer rate through the system, an optimized assignment of transmission lines to senders has to be determined.

As another example, consider a computer system including a number of processor units each having a certain processing capacity. On such a computer system, a number of tasks shall be performed, where each task has a certain capacity demand, i.e. a processing capacity needed for performing the task. Further, each task may, in principle, run on a number of selected ones of said processor units and my as well be split for running on different processor units. In this case, the tasks may be seen as the demanders or demands with the capacity demand being the demand amount, and the processor units may be seen as the supplies or resources with their processing capacity being the supply amount. The tasks shall be assigned to the processing units in such an optimized order that as much as possible of the processing demand is satisfied by the processors.

Optimization problems as discussed above may be solved e.g. by calculating all possible permutations of distributions of supply amounts over the demanders. Due to the huge amount of calculation time which is necessary to calculate these permutations, this is to be done by computers. However, even on powerful computers, the calculation time which is necessary to calculate the permutations is long, as soon as the number of demanders and supplies exceeds a certain number, because the number of permutations grows factorially. The certain number, however, is in many applications smaller than the actual number of demanders and supplies so that it is not possible to find the optimized assignment within a reasonable time scale for these applications.

It is therefore an object of the present invention, to provide a method for optimizing the order of assignment of a number of supplies to a number of demanders, where each supply has a certain supply amount and each demander has a certain demand amount which is to be satisfied by the supplies, by which the calculation time for optimizing the assignment can be reduced.

It is a further object of the present invention, to provide a device, a computer program product and a storage device which are adapted to performing the inventive method.

The first object is solved by a method for optimizing the order of assignment of a number of supplies to a number of demanders as defined in claim 1, by a method for balancing a number of loan accounts with a number of collateral securities, as defined in claim 15, by a method for optimizing the data transfer through a transmission system, as defined in claim 29, and by a method for optimizing the order of assignment of a number of tasks to a number of processors, as defined in claim 43.

The further object is solved by a device for determining an optimized assignment of a number of supplies each having a certain supply amount to a number of demanders each having a certain demand amount, as defined in claim 57, by a device for balancing a number of loan accounts with a number of collateral securities, as defined in claim 61, by a device for optimizing the data transfer through a transmission system, as defined in claim 65, and by a device for optimizing the order of assignment of a number of tasks to a number of processors, as defined in claim 69, a computer program product as defined in claim 73, 74, 75, or 76 and a storage medium as defined in claim 77, 78, 79, or 80.

The dependent claims define further developments of the invention.

The inventive method for optimizing the order of assignment of a number of supplies or resources, such as computer processor units, to a number of demanders or demands, such as tasks to be processed by the computer processor units, where each supply or resource has a certain supply amount (or resource amount), such as a processing capacity, and each demander or demand has a certain demand amount which is to be satisfied by said supplies, such as a capacity demand, i.e. a processing capacity needed for processing the task, comprises the steps of:
building a network in which the supplies are represented by supply vertices connected to a sink vertex via sink edges of a flow capacity which represents the supply amount of the respective supply, the sink vertex being sink of a network flow; in which the demanders are represented by demander vertices connected to a source vertex via source edges of a flow capacity which represents the demand amount of the respective demander to be satisfied, the source vertex being source of a network flow; and in which supply vertices and demander vertices are connected by edges of certain flow capacities;
determining an optimized network flow distribution of flow values through the edges by an iterative flow-method; and
deriving the optimized order of assignment from the optimized network flow distribution by assigning the supply vertices to the demander vertices in correspondence to the flow values of the connecting edges.

The inventive method is able to optimize the order of assignments of a number of supplies to a number of demanders much faster than the methods according to the state of the art. Therefore, an increased number of resources and demanders can be assigned to each other within a reasonable tame scale. Thus, the number of applications to which the optimization method is applicable with respect to the calculation time is increased compared to the state of the art methods. Further, with the optimized assignment, the demand amount of each demander may be satisfied by at least a sub-set of the supplies such that the sum of the remaining, i.e. the unsatisfied, demand amounts is minimized.

As an example, the supplies may be any kind of processors, i.e. processing capabilities or units, e.g. in form of computer processors, each offering, as supply amount, a certain processing capacity for tasks to be performed. The tasks then are the demanders or demands and their processing demand, i.e. the processing capacity needed for processing or performing the task, the corresponding demand amounts. With the optimized assignment of demanders to supplies, i.e. tasks to processors, it can be achieved that the total processing capacity, i.e. the sum of all processing capacities, or at least a maximum fraction of the total processing capacity is used by the tasks.

As a further example, the supplies may be transmission lines of a transmission system or transmission network, where each transmission line offers, as supply amount, a certain transmission rate to senders sending data by a certain data rate The senders then would be the demanders or demands and their data rates, the corresponding demand amounts. With the optimized assignment of demanders to supplies, i.e. senders to transmission lines, it can be achieved that the total transmission rate, i.e. the sum of all transmission rates, or at least a maximum fraction of the total transmission rate is used by the senders.

As an example for a commercial application of the inventive method, the demanders or demands may be loans, each having, as demand amount, a certain loan value. The loans are to be balanced with collateral securities, which are the supplies or resources, where each security has, as supply or resource amount, a security value. With the optimized assignment of demanders to supplies, i.e. loans to securities, it can be achieved that the total security value, i.e. the sum of all loan values, or at least a maximum fraction of the total security value is offset against the loans, i.e. the total amount of unsecured loan or credit is minimized.

The network which is built during the inventive method can be seen as a directed bipartite graph including a source vertex and a sink vertex. The use of a iterative flow-method is particularly suited for optimizing the network flow through edges in such graphs, as constraints for the flows may easily be taken into account.

In particular, the iterative flow-method may comprise a discharge operation pushing a flow from an active vertex at which the sum of the incoming network flow is higher than the sum of the outgoing network flow along an admissible edge, where the admissibility of an edge is defined by a label of the vertex which is connected to the active vertex by the respective edge. It may further comprise a relabeling operation changing the label of the active vertex if there is no admissible edge along which the discharge operation can be performed. During determining an optimized network flow distribution, the discharge operation may push flows from demanders to supplies, as well as, form supplies to demanders. In particular, the discharge operation may be performed iteratively for demander vertices and supply vertices.

When the label of the vertex to be discharged is Ψ(v), the label of an vertex connected by an edge is Ψ(w), and an admissible edge is characterized by Ψ(v)=Ψ(w)+1, then a suitable relabeling operation may increase the label Ψ(v) of the vertex to be discharged by one.

By using the method comprising the described discharge operation, the iterative flow-method may be designed such that the network flow respects the capacity constraints of the edges in any iteration step. Further, the optimal flow derived from the iterative flow-method comprising the discharge operation meets the conditions that, for all vertices except the source and the sink vertex, the inflow of a vertex equals its outflow, and that there is no further augmenting path from the source to the sink.

An optimal network flow can be determined within a reasonable calculation time when the flow-method comprises the steps of
determining an upper limit for the highest possible total flow through the edges, where the total flow is the network flow through the edges from the source vertex to the sink vertex; and
iteratively distributing the network flow through the edges until at least one of the conditions is fulfilled:
i) the network flow corresponds to the upper limit of the highest possible total flow,
ii) the sum of the incoming network flow at a vertex equals the sum of the outgoing network flow of said vertex for each resource vertex and for each demander vertex,
iii) the number of iterations has reached a given maximum value.

The assignment of the supply vertices to the demander vertices may be performed by an iterative assigning operation. This operation may be designed such that, in a first stage, the assigning operation assigns a supply vertex to a demander vertex only if these vertices are connected by an edge for which the flow value equals the capacity. By this assignment, it can be ascertained that, for a number of supplies and/or demanders, either a demand amount is satisfied by only one supply, or a supply amount is completely used by a single demander.

In particular, the assigning operation may first assign supply vertices to such demander vertices which are connected to the respective supply vertex by an edge for which the flow value equals the flow value of the corresponding source edge, before it assigns supply vertices to such demander vertices which are connected to the respective supply vertex by edges for which the flow value is equal to or higher than a remaining flow value of the corresponding sink edge which has not yet been assigned to a demander vertex. This offers the possibility to set a high priority on satisfying a demander by a single supply.

The fist stage is preferably performed until all supply vertices and demander vertices which are connected by edges for which the flow value equals the capacity are assigned.

Further, the assigning operation may comprise a second stage, which assigns supply vertices to demander verticess if the flow value of the connecting edge corresponds to the flow value of the corresponding source edge reduced by a fraction of its demand amount already assigned to a supply, or to the flow value of the corresponding sink edge reduced by a fraction of its supply amount already assigned to a demander vertex. In particular, the assigning operation of the second stage may first assign such supply vertices to demander vertices for which the flow value of the connecting edge corresponds to the flow value of the corresponding source edge reduced by a fraction of its demand amount already assigned to a supply.

In the inventive method, the certain flow capacity of an edge may be given by the smaller one of the supply amount of the supply and the demand amount of the demander which are connected by said edge. In the network, the demand amount of a demander is represented by the capacity of the source edge connecting the respective demander vertex to the source vertex, and the supply amount of a supply is represented by the capacity of the sink edge connecting the respective supply vertex to the sink. Thus, the certain flow capacity of an edge connecting a demander vertex to a source vertex is given by the smaller one of the capacity of the respective source edge and the capacity of the respective sink edge.

The inventive method may be used for doing optimization of assignments in various technical and commercial fields.

It may, for example, be used for balancing loan accounts with collateral securities. In this case, a demander and a corresponding demand amount represent a loan account and its loan value (i.e. the amount of credit), respectively. Further, a supply and a corresponding supply amount represent a collateral security and its security value, respectively. The method then returns an optimized order, in which the securities are to be offset against, i.e. to be assigned to, the loan accounts such that, when a total loan value is the sum of the loan values of all loan accounts, the fraction of the total loan value which is offset by the collateral securities, is maximized. In other words, the total loan value which cannot be balanced by the collateral securities is minimized.

The inventive method may also be used for optimizing data transmission in a transmission system comprising senders each sending with a certain data rate and transmission lines each providing a certain transmission rate. In this case, a demander and a corresponding demand amount represent a sender and its data rate. Further, a supply and a corresponding supply amount represent a transmission line and its transmission rate. The method returns an optimized order in which the transmission lines are to be assigned to the senders such that a maximum of a total data rate, i.e. the sum of the data rates of all senders, is transmitted by the transmission lines. In other words, a fraction of the total data rate which cannot be transmitted by the transmission lines is minimized. Thus, the throughput through the transmission system is optimized.

Further, the inventive method may be used for distributing a number of tasks over a number of processor units, where a task may be distributed over certain ones of said number of processors. Each processing unit has a certain processing capacity and each task a certain capacity demand, i.e. a processing capacity which is needed for performing the task. In this case, a demander and a corresponding demand amount represent a task and its processing demand, whereas a supply and a corresponding supply amount represent a processor and its processing capacity. The method returns an optimized order in which the processors are to be assigned to the tasks such that, if possible, a total capacity demand, i.e. the sum of the capacity demands of all tasks, is satisfied by the processors, or at least a fraction of the total capacity demand which cannot be satisfied by the processors is minimized.

An inventive device for determining an optimized assignment of a number of supplies or resources, such as computer processor units, each having a certain supply amount or resource amount, such as a processing capacity, to a number of demanders or demands, such as tasks to be processed by the computer processor units, each having a certain demand amount to be satisfied by said supplies or resources, such as a capacity demand, i.e. a processing capacity necessary to process the task, in which, after the assignment, the sum of unsatisfied demand amounts is minimized, comprises:
a supply input unit for inputting supply data representing supplies and their supply amounts;
a demander input unit for inputting demander data representing demanders and their demand amounts,
an access input unit for inputting access data representing, for each demander, the corresponding supplies, which can be accessed to by the respective demander for satisfying its demand amount;
a network construction unit for constructing, on the basis of the supply data, the demander data and the access data, a network comprising:
   a) a supply vertex for each supply,
   b) a demander vertex for each demander,
   c) a sink vertex,
   d) a source vertex,
   e) edges, each having a certain flow capacity and connecting a supply vertex and a demander vertex,
   f) sink edges, each connecting the sink vertex to one of the supply vertices and having a flow capacity representing the supply amount of the respective supply, and
   g) source edges, each connecting the source vertex to one of the demander vertices and having a flow capacity representing the demand amount of the respective demander;
a network flow unit for determining an optimized network flow distribution through the network, the optimized network flow being represented by flow values through the edges; and
an assignment unit for assigning the supplies to the demanders by assigning the supply vertices to the demander vertices in correspondence to the flow values of the connecting edges.

The inventive device for determining an optimized assignment of a number of supplies each having a certain supply amount to a number of demanders each having a certain demand amount allows for performing the inventive method for determining an optimized assignment of a number of supplies to a number of demanders.

An inventive device for balancing a number of loan accounts with a number of collateral securities, where each loan account has a certain loan value and each collateral security has a certain security value and wherein the collateral securities are to be offset against the loan accounts, comprises:
a security input unit for inputting security data representing collateral securities and their security values;
a loan input unit for inputting loan data representing loan accounts and their loan values,
an access input unit for inputting access data representing, for each loan account, the corresponding collateral securities, which can be offset against the respective loan account;
a network construction unit for constructing, the basis of the security data, the loan data and the access data, a network comprising:
   a) a security vertex for each security,
   b) a loan vertex for each loan,
   c) a sink vertex,
   d) a source vertex,
   e) edges, each having a certain flow capacity and connecting a security vertex and a loan vertex,
   f) sink edges, each connecting the sink vertex to one of the security vertices and having a flow capacity representing the security value of the respective collateral security, and
   g) source edges, each connecting the source vertex to one of the loan vertices and having a flow capacity representing the loan value of the respective loan account,
a network flow unit for determining an optimized network flow distribution through the network, the optimized network flow being represented by flow values through the edges; and
an assignment unit for offsetting the collateral securities against the loan accounts by assigning the security vertices to the loan vertices in correspondence to the flow values of the connecting edges.

The inventive device for balancing a number of loan accounts with a number of collateral securities allows for performing the inventive method for balancing a number of loan accounts with a number of collateral securities.

An inventive device for determining an optimized data transfer through a (mono-, bi- and/or multidirectional) transmission system comprising a number of senders and a number of transmission lines, where each transmission line has a certain transmission rate and each sender is connected to a number of said transmission lines and has a certain data rate, comprises:
a transmission line input unit for inputting transmission line data representing transmission lines and their transmission rates;
a sender input unit for inputting sender data representing senders and their demand data rates,
an access input unit for inputting access data representing, for each sender, the corresponding transmission lines, which can be accessed by a sender for transferring data;
a network construction unit for constructing, on the basis of the transmission line data, the sender data and the access data, a network comprising:
   a) a transmission vertex for each transmission line,
   b) a sender vertex for each sender,
   c) a sink vertex,
   d) a source vertex,
   e) edges, each having a certain flow capacity and connecting a transmission vertex and a sender vertex,
   f) sink edges, each connecting the sink vertex to one of the transmission vertices and having a flow capacity representing the transmission rate of the respective transmission line,
   g) and source edges, each connecting the source vertex to one of the sender vertices and having a flow capacity representing the data rate of the respective sender;
a network flow unit for determining an optimized network flow distribution through the network, the optimized network flow being represented by flow values through the edges; and
an assignment unit for assigning the transmission lines to the senders by assigning the transmission vertices to the sender vertices in correspondence to the flow values of the connecting edges.

The inventive device for determining an optimized data transfer through a transmission system allows for performing the inventive method for optimizing the data transfer through a transmission system. It is applicable for wire based transmission lines as well as for wireless transmission lines.

An inventive device for determining an optimized order of assignment of a number of tasks to a number of processors, where each processor has a certain processor capacity and each task has a certain capacity demand which is to be satisfied by at least one of said processors, comprising:
a processor input unit for inputting processor data representing processors and their processing capacities;
a task input unit for inputting task data representing tasks and their processing demands,
an access input unit for inputting access data representing, for each task, the corresponding processors, which can be accessed by a task;
a network construction unit for constructing, on the basis of the processor data, the task data and the access data, a network comprising:
   a) a processor vertex for each processor,
   b) a task vertex for each task,
   c) a sink vertex,
   d) a source vertex,
   e) edges, each having a certain flow capacity and connecting a processor vertex and a task vertex,
   f) sink edges, each connecting the sink vertex to one of the processor vertices and having a flow capacity representing the processing capacity of the respective processor,
   g) and source edges, each connecting the source vertex to one of the task vertices and having a flow capacity representing the processing demand of the respective task;
a network flow unit for determining an optimized network flow distribution through the network, the optimized network flow being represented by flow values through the edges; and
an assignment unit for assigning the processors to the tasks by assigning the processor vertices to the task vertices in correspondence to the flow values of the connecting edges.

The inventive device for determining an optimized order of assignment of a number of tasks to a number of processors allows for performing the inventive method for optimizing the order of assignment of a number of tasks to a number of processors.

In all the inventive devices, the different input units do not necessarily need to be different software or hardware entities but can also be implemented by a single entity. Distinguishing between the different data types may, for example, be performed by characterizing sequences which indicate whether the inputted data represents supply data, demander data, or access data.

In addition, although being different physical entities, the input units may be integrated in a single device.

Furthermore, the network construction unit, the network flow unit and the assignment unit may either be implemented in form of different processor units, i.e. a network construction processor, a network flow processor, and an assignment processor, or in form of a single calculator unit, e.g. single processor. In particular, if implemented in form of a single processor, the network construction unit, the network flow unit, and the assignment unit may be implemented in software form. However, it is also possible to implement the network construction unit, the network flow unit, and the assignment unit in hardware form.

According to the invention, a computer program product for optimizing the order of assignment of a number of supplies to a number of demanders comprises instructions which, when loaded into a computer, cause said computer to perform a method according to the invention

According to the invention, a storage medium, such as, e.g., a DVD, a compact disc, a hard disk drive etc, comprises stored data which represent a computer program product according to the invention.

Although a number of applications for the inventive method and the inventive device have been described, the present invention is not intended to be limited to the described applications.

Further features, properties, and advantages will become clear from the following description of embodiments in conjunction with the accompanying figures, wherein

FIG. 1 shows loan accounts and collateral securities which are to be offset against the loan accounts,

FIG. 2 shows a network representing the loan accounts and the collateral securities,

FIG. 3 gives an idea of a network related to collateralized loans of a commercial enterprise,

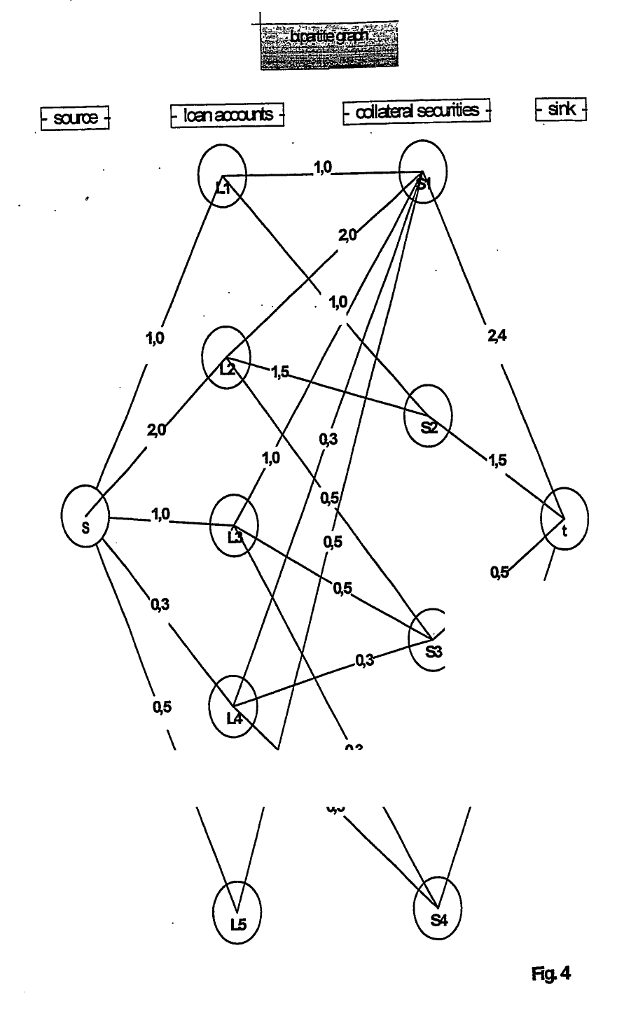

FIG. 4 shows a bipartite graph representing a network which would have been constructed by a network builder for the collateralized loans of FIG. 1,

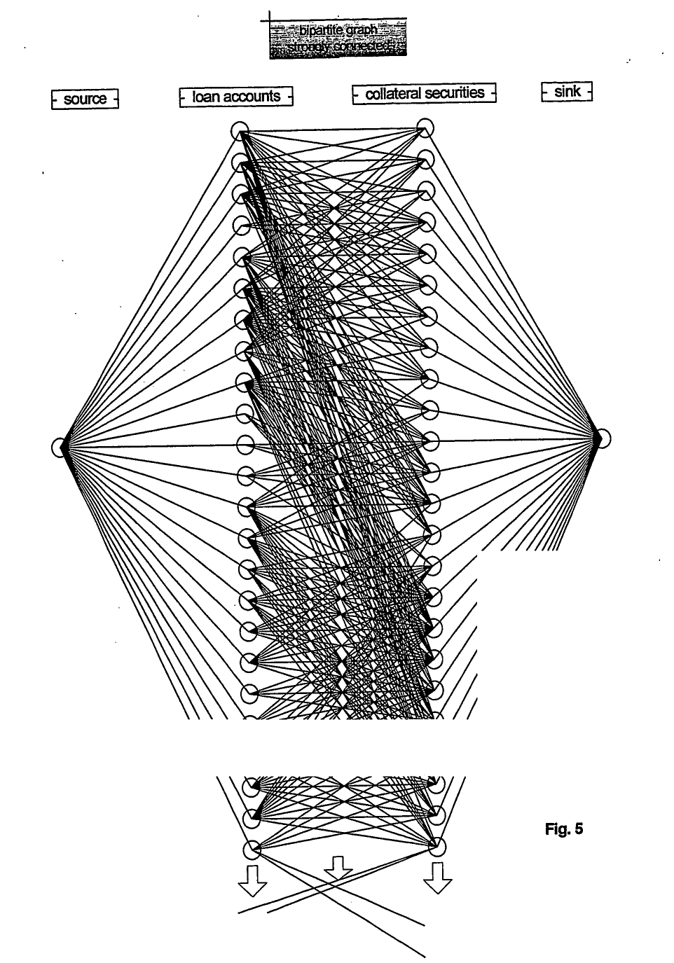

FIG. 5 shows a bipartite graph representing a typical network of collateralized loans of a commercial enterprise,

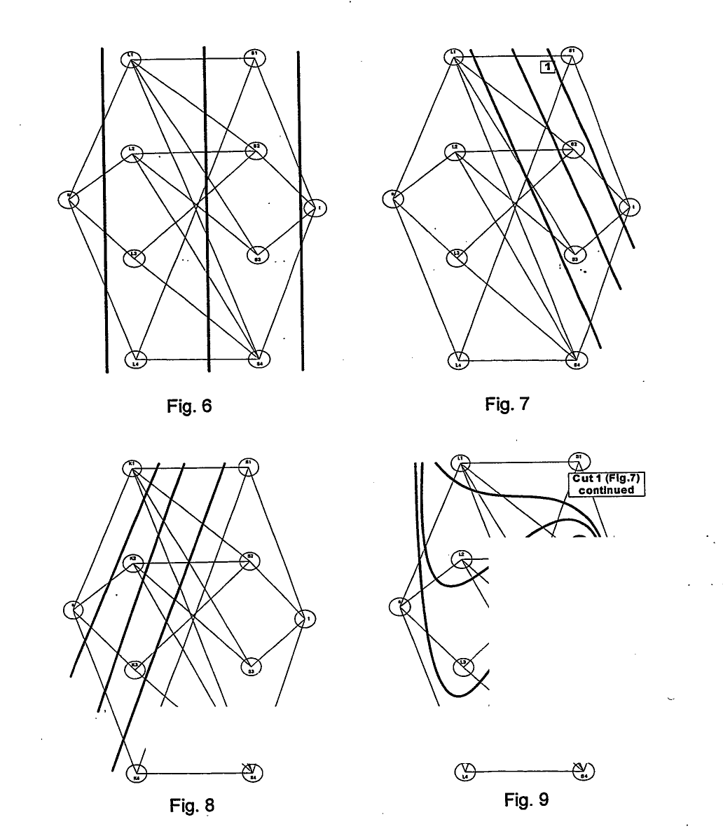

FIGS. 6-9 show s-t-cuts of a bipartite graph,

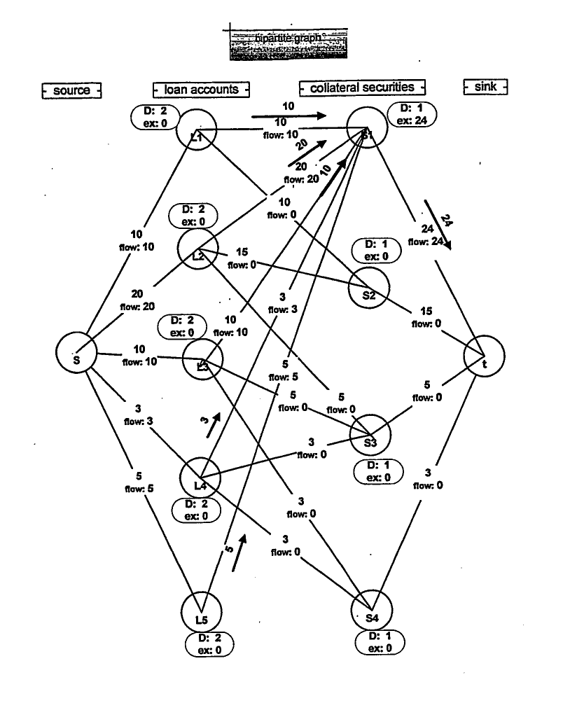

FIG. 10 gives an idea of the relabeling operation of the inventive method,

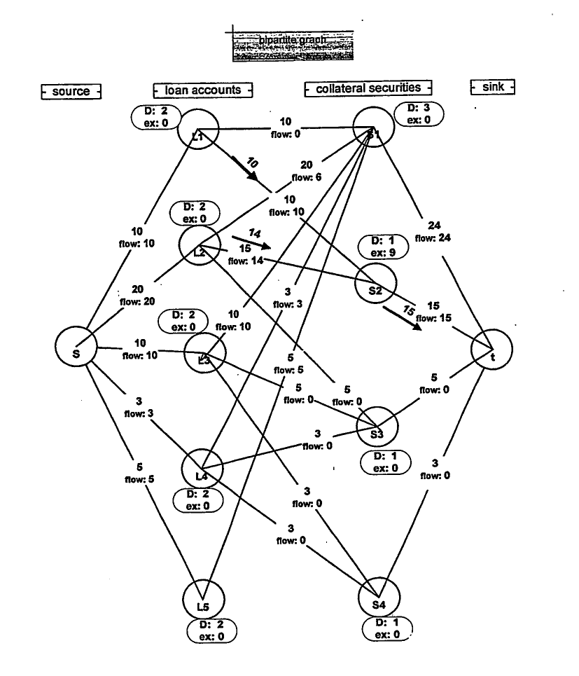

FIGS. 12-16 show the graph of FIG. 4 at different stages of the inventive method, and

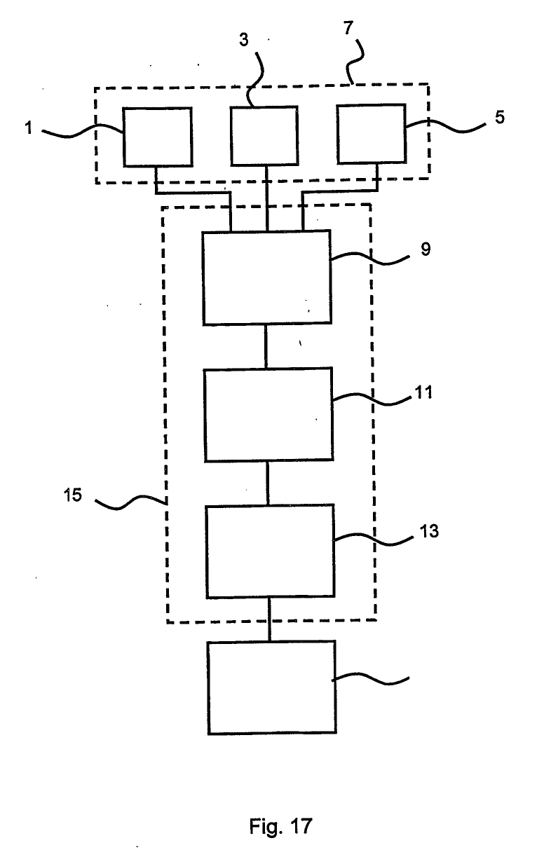

FIG. 17 shows a device for performing the inventive method.

As a preferred embodiment of the invention, a method for balancing loan accounts with collateral securities is described, in which the order of security assignments to loan accounts will be optimized.

In the present embodiment, the loan accounts and the corresponding loan values represent the demanders or demands and their demand amounts. The securities and the corresponding security values represent the supplies or resources and their supply amounts (resource amounts). Balancing the loan accounts with the collateral securities will be performed such that the total amount of unsecured loans is minimized by optimizing the order of assignment of securities to loans accounts, i.e. supplies to demanders.

First, an overview over the optimization method is given, after which a detailed technical description of the embodiment follows.

1. Optimization Method

Optimization of the order of securities assignments is provided by a system that consists of two parts, a network flow method that results in an optimal flow and a method that derives the optimal order from this flow.

1.1. The Network Flow Method

The flow optimization method results in an optimal flow of capital (credit) from vertices (or nodes) representing the loan accounts as preferred demanders or demands according to the invention to the vertices representing collateral securities as preferred supplies or resources according to the invention. A short overview is given here to explain this method.

The amount of credit as a preferred demand amount of the invention balanced by a collateral security assigned to a loan account depends on the order in which the securities are offset against the assigned loan accounts. The total amount of unsecured credit depends on this order as well—as shown in the introduction: it is only the order of these assignments that determines the total amount of unsecured credit. As Silvio Turrini (*1, 1996, digital, Western Research Laboratory) has pointed out, optimization problems usually deal with sets of independent values. In this case however the order of assignments “constitutes the n-tupla of values” and it is this order that “differentiate one input from another and the value of any parameter at a given position in the n-tupla is clearly dependent on all the others” (*1, p. 1). The method presented here is an extremely fast method, in particular an extremely fast algorithm, that may generally replace the slow algorithms dealing with permutation spaces in different other ways.

After a network builder has built up a network that can be represented by a directed bipartite graph including a source vertex s and a sink vertex t (see FIG. 4), and after the optimal value of the total flow that should reach the sink vertex has been ascertained by an s-t-cut of minimum capacity, a special network preflow-push method sends a maximum amount of flow from a source vertex s to a sink vertex t. It works by pushing flows along individual edges of the network, each flow respecting the capacity constraints, at the respective edges resulting in successive preflows until an optimal flow can be obtained. This network flow method is suited for bipartite graphs, and it is suited especially to the task of determining an optimal order of the assignments, hence superseding other methods for optimization in permutation spaces by a preflow-push optimization method with an incomparably better algorithmic efficiency. Thus the goal of this method is not the optimal flow but an optimal order (i.e. to derive an optimal permutation from the network flow, a permutation that would lead just to this distribution of flows). The preflow-push method is suited to this goal by respecting additional constraints defined for all pushes of flows along the edges, by handling reflows at each edge the same way as the preceding flows, and by applying a special label method. So the characteristic feature of this optimization system is a network flow design that enables to derive the corresponding optimal permutation.

General Flow Characteristics:

During the preflow stage of the flow method—while each preflow respects the capacity constraints at each edge—excess flow may occur at the vertices of the network: the flows entering a vertex (inflows) may exceed the flows leaving the respective vertex (the outflows).

The resulting network preflow is optimal if the amount of flow that reaches the sink corresponds to the value ascertained before by the min s-t-cut. Then the preflow-push method or algorithm stops—the flow is optimal because there is no further augmenting path (from the source to the sink). The method then converts the preflow into a flow by reducing the excess flow at each vertex, so that inflows=outflows at every vertex (except for source and sink).

The final optimal flow meets the following conditions:
1. The resulting network flow respects the capacity constraints at each edge. (This condition has already been respected during the preceding preflows)
2. for all vertices of the network (except source and sink) inflows=outflows
3. There is no further augmenting path from the source to the sink.

The network represented by the graph of FIG. 4 would have been constructed by the network builder for the collateralized loans of FIG. 1. The capacities of the edges are indicated in million US $. Please note that the method described here operates with integer values—in this case with cents rather than with US $.

FIG. 5 is a representation of a bipartite graph for a typical network of collateralized loans of a commercial enterprise. These graphs tend to be strongly connected.

1.2. Deriving the Optimal Order from the Values of the Network Flow

The last stage of the optimization method comprises steps, e.g. in form of an algorithm, that derive the optimal order from the capital flows (as the preferred network flow) on each edge. The system obtains the optimal order by offsetting the securities against the loan accounts, i.e. assigning demanders to supplies, in an order that corresponds exactly to the values of the network flow. This is done by an iteration that chooses the edges representing the credit-security assignments in such an order that at each step of the iteration the values of the edge flows correspond to the values that will be obtained when offsetting the securities against the loan accounts exactly in this order.

In the following, a detailed technical description of the optimization will be given.

2. Technical Description

2.1. The Network Construction Step or Algorithm

The optimization system first constructs a directed graph. This “network construction” step or algorithm
1. begins selecting a single loan account (representing a demander or demand according to the invention), then—in an iterative process
2. it selects all securities (representing supplies or resources according to the invention) assigned to all those loan accounts that are not yet searched for assigned securities—and establishes the edges that link these securities to the loan accounts
3. selects all loan accounts assigned to all those securities that are not yet searched for assigned loan accounts—and establishes the edges that link these loan accounts to the assigned securities
4. continues with step 2-3 until no more loan accounts and no more securities can be found that are linked to that network

At this stage the graph corresponds to the graphs shown in FIG. 2 and FIG. 3.

The construction step or algorithm then completes the directed graph. It assigns the capacities to each edge:

1. It implements a source vertex (s), creates the edges from the source vertex to all loan account vertices (as preferred demander vertices according to the invention) and assigns capacities to each edge: The value of the capacity of each edge leaving the source vertex and entering a loan account vertex is the corresponding amount of credit (as a preferred demand amount according to the invention).

2. then the construction step or algorithm assigns capacities to all edges that leave the loan account vertices and enter the security vertices (as preferred supply vertices according to the invention). The capacity of each of these edges is the minimum value of either of the two corresponding vertices—either the amount of credit (demand amount according to the invention) or the value of the assigned security (supply amount according to the invention).

3. Finally the step or algorithm implements a sink-vertex (t), creating edges from all security vertices (supply vertices) to the sink-vertex and it assigns capacities to each of these edges. The capacity of each edge leaving the security vertex and entering the sink-vertex is the value of the corresponding security—represented as an integer value.

FIG. 5 shows a graph constructed at this stage. The representation of the small graph of FIG. 4 also displays the capacities.

The flow method operates on integer values, so all capacities and every flow is represented in this format.

2.2. Implementing the Bipartite Graph: Technical Features

The bipartite graph is implemented by means of two- and three-dimensional tables (these tables are of fixed maximum size in order to avoid computer memory allocation at any point during the course of the method), linked with pointers. Some details are explained here.

2.2.1. The Loan Account Vertices (as Preferred Demander Vertices According to the Invention)

A table is implemented for the loan account vertices. Each row represents one loan account vertex as a preferred demander or demand vertex and has the following attributes/values:

Proper Values of the Vertex
the identification code of the loan account vertex,
the amount of credit (integer value), which represents in the present embodiment the demand amount,

Values Referring to the Edges
number of edges leading to coll. security vertices,
imbedded table with pointer to the edges leading to coll. security vertices,

Total Flow Values
S-L-flow: flow on the edge from the source vertex to the current loan account vertex
L-S-flow: total flow from current loan account vertex over all edges leading to security vertices (reflows are always subtracted from flow)
remark: the excess flow at a loan account vertex is inflow—all outflows of the current loan account vertex. That is of course S-L-flow minus L-S-flow

“Distance” Label
a label (small integer) is initially set to the value 2, as the distance of the loan account vertex to the sink. During the course of the preflow method, all “distance”-labels are up-dated and they control the flows in such a way that the flows correspond to the effects of a coherent quick and effective determination of corresponding permutations (and their calculation)

Value for the Derivation of the Optimal Order (Last Stage of Optimization Method)
unsecured amount of credit. Initially this is the total amount of this loan account
   2.2.2. The Collateral Security Vertices (as Preferred Supply Vertices According to the Invention)

Each row of this table comprises the values of one collateral security vertex as a preferred supply or resource vertex:

Proper Values of the Vertex
the identification code of the collateral security vertex,
the value of the security (integer value), which represents in the present embodiment the supply amount

Values Referring to the Edges
pointer to the first edge that enters the current vertex (edges leaving security vertices)

Values Referring to the Flow
L-S-flow: total flow on all edges from loan account vertices to the current security vertex
s-t-flow: flow on the edge from current security vertex to the sink-vertex
pointer to the corresponding row of the table of active security vertices
remark: the excess flow at a collateral security vertex is inflow minus all outflows of the current security vertex. That is of course L-S-flow minus s-t-flow

“Distance” Label
a label (small integer) that initially is set to the value 1 which is the distance of the coll. security vertex to the sink. During the course of the preflow method, all “distance”-labels are updated and they control the flows in such a way that the flows correspond to the effects of a coherent quick and effective determination of corresponding permutations (and their calculation)

Value for the Derivation of the Optimal Order (Last Stage of Optimization Method)
value of the security not yet balanced with loan accounts. Initially this is the total amount of the value of this collateral security
   2.2.3. Edges Loan Account Vertices (Demander Vertices)->Security Vertices (Supply Vertices)

Each row of this table represents one edge that leaves a distinct loan account vertex and enters a distinct security vertex and comprises its values:

Proper Value of the Edge
capacity of the current edge

Values Referring to the Vertices
pointer to the loan account vertex from which the current edge is leaving
pointer to the security vertex that is entered by this edge

Flow Values
flow on this edge from the loan account vertex to the security vertex (reflows are subtracted. All flows are non-negative)

Value Referring to the Optimal Order
pointer to the corresponding row of the table in which the loan account->security vertex edges are entered in correspondence with the optimal order derived from the network flow. This attribute is managed by that part of the method that derives the optimal order from the flow. The pointer is set when the flow on this edge has been balanced with the loan account vertex. The pointer is null otherwise.
   2.3. Tables to Manage Network Flow and Ascertainment of the Optimal Order
   2.3.1. Two Tables: Activation of Loan Account Vertices (Demander Vertices)/Coll. Security Vertices (Supply Vertices)
pointer to the corresponding loan account/security vertex
logic value set to ‘true’ if vertex is set active
excess flow of loan account/security vertex

The total number of active loan account vertices (as active demander vertices) and the number of active security vertices (as active supply vertices) is always updated if a vertex is set active/non active

2.3.2. Main Result Table: Optimal Order of Loan Account (as Demander)->Security (as Supply) Assignments

pointer to the edges linking the loan account vertices to the security vertices. The pointers are entered (from the first to the last row in this table) in the optimal order of the assignments they are pointing to.
   2.4. s-t-cut of Minimum Capacity

An s-t-cut is a partition of the set of vertices into two subsets such that the source vertex s is member of one subset and the sink vertex t is member of the other subset. To determine the capacity of an s-t-cut we focus on the subset that include the source and there we only consider the capacity of the edges that leave this subset (directed toward the subset that includes the sink). The capacity of a cut is the sum of the capacities of these edges. And the s-t-cut of minimum capacity would always ascertain the value of an optimal flow. But as it is not the flow that shall be determined (but an optimal order instead), the method doesn't process all s-t-cuts and it ascertains a value that is greater or (in most cases) equal to a maximum flow—and this value is one criterion that ends the preflow stage of the flow method.

An abridged method of ‘s-t-cut of minimum capacity’ is applied to find a maximum value that the network flow cannot exceed. This value is the minimum of the total capacities of each of the following cuts, where the “total capacity” of a cut is the sum of the capacities of the edges “leaving” these cuts in this directed graph (directed from the source to the sink vertex):

2.4.1. The minimum of all ‘vertical’ cuts (see FIG. 6), i.e.

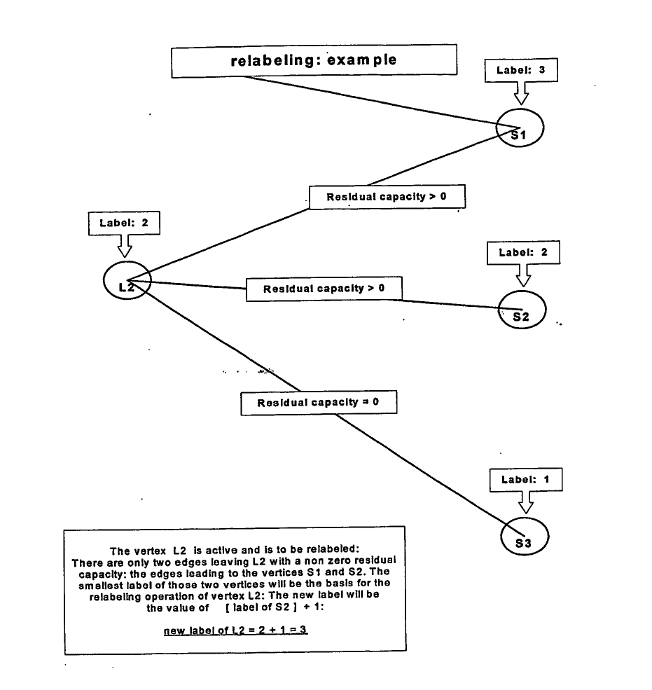

2.4.1.1. the total value of loan accounts (as total demand amount according to the invention),
2.4.1.2. the total value of all collateral securities (as total supply amount according to the invention)
2.4.1.3. the total value of all loan account->security assignments.
   2.4.2. The minimum of all cuts shown in FIG. 7, each cut excluding one more security vertex with an edge leaving the cut from the security vertex toward the sink—from top to bottom. Then each of these cuts is continued as indicated in FIG. 9 (for cut 1), each continuation including one more loan account vertex with an edge leaving the cut from the source to the included loan account vertex from top to bottom.

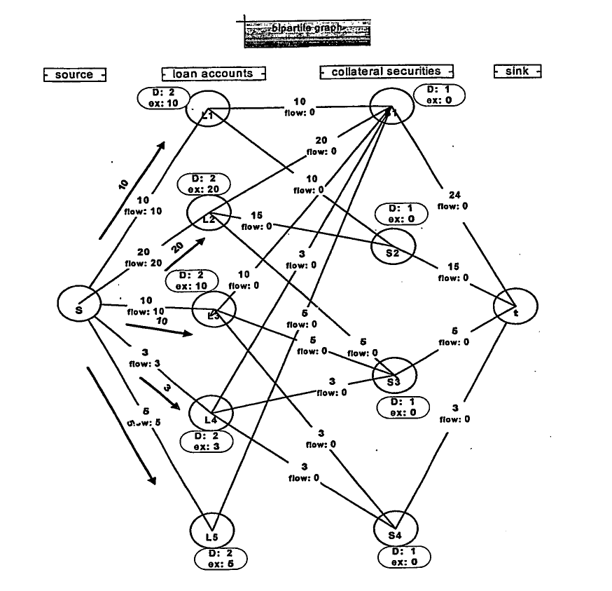

2.4.3. The minimum of all cuts shown in FIG. 8, each cut excluding one more loan account mode with an edge leaving the cut from the source to the loan account vertex—from top to bottom. Then each of these cuts is continued, each continuation including one more security vertex with an edge leaving the cut from the security vertex to the sink—in inverse proportion to the pattern of FIG. 9 (from top right-hand to bottom left-hand).

2.4.4. The minimum of all cuts as explained in 2.4.2. and 2.4.3.—but with progressive exclusion/inclusion from bottom to top.

The minimum value (of capacity) of all these cuts will hereinafter be called the “min s-t-cut value”.

2.5. The Network Preflow

2.5.1. Standard Rules and Terminology

The following rules are standard rules for the network preflow-push method or algorithm (s. Cherkassky/Goldberg.3 Ahuja/Magnanti/Orlin.5 and Korte/Vygen.6)

2.5.1.1. On each edge the flow has to be less or equal to the capacity of the edge:

Let E be the set of edges of graph G, let e denote any edge of this set, let V be the set of vertices of graph G, let v denote any vertex of graph G, let f(e) denote the current flow on edge e, and let u(e) be the capacity of edge e, then
f(e)≦u(e) for all e ε E(G)
2.5.1.2. During the preflow stage of the method the flows “entering a vertex” may exceed the flows leaving the vertex (in direction source->sink). So let v be a vertex in V, let δ⁻(v) be the number of edges entering a vertex v (in-degree), let δ⁺(v) be the number of edges leaving the vertex v (out-degree), and let s denote the source-vertex, let t denote the sink, then the excess flow=

$${\sum }_{e ∈ {δ}^{-} ( v )} f ( e ) - {\sum }_{e ∈ {δ}^{+} ( v )} f ( e ) \geq 0 for all v ∈ V ( G ) \backslash \{ s \} ( {see }^{*} 6 )$$

2.5.1.3. Active Vertices

Active vertices are those vertices with excess flow (see 2.5.1.2). The discharge operation manages the flows from active vertices. Let v be an active vertex and let w be an adjacent vertex (with at least one edge e′ leaving v and entering w): If an edge e′ leaving the vertex v is “admissible” (depending on the distance labels of v and the adjacent vertex w—see 2.5.1.4), the discharge operation pushes (excess) flow according to the capacity of this edge.

2.5.1.4. Discharge Operation: Admissible Edges

The discharge operation pushes flows from active vertices along admissible edges in the residual graph. The term “admissible” is defined here: If Ψ is the labeling function for V(G), then an edge e(v, w) (leaving vertex v and entering vertex w) is admissible if Ψ(V)=Ψ(w)+1 (s. *6, p. 164).

2.5.2. Special Rules Applied to the Preflow

2.5.2.1. Special Flow Method: General Remarks

The standard preflow-push method is designed to push flows in a complex network.

In such networks the flow is controlled by distance labels in order to find the shortest viable path from the source to the sink: the flows are pushed “to the nodes that are closer to the sink. If the active node we are currently considering has no admissible arc, we increase its distance label ( . . . )” (*5, p. 224). Please note the equivalence of terms: “node”=“vertex”, “arc”=“edge”.

But in the preflow-push method presented here flows are pushed along the edges of a bipartite graph in order to find an optimal permutation. Flows may be pushed “forwards” as well as “backwards” at (admissible) edges, and later forwards again on the same edge—updating “distance” labels if no admissible edge exists. At the start of the method these labels really are “distance” labels, but in the course of the discharge operations the labels turn to be constraints that guarantee that different permutations will occur. This goal to produce a flow with the effect of calculating permutations is also supported by the definition of priority-rules for each flow pushed, rules that give priority to one or several edges out of all admissible edges leaving a certain vertex (see 2.5.5.3.1.1., and 2.5.5.3.2.1.).

2.5.2.2. Termination of the Flow Method

The preflow stage of this method terminates when the flow to the sink has reached the value of the min s-t-cut—hence the optimal value. In most cases there are still active vertices when the flow method ends—and that is an important difference to standard preflow methods. In a standard network preflow-push method “the algorithm terminates when the network contains no active node” (*5, p. 225). The reason for this different criterion for termination is the fact that with those standard methods excess flow should flow back to the source in the normal course of the flow method. But the method presented here controls flows and distance labels accordingly to the effects of a permutation. Excess flow should only be sent back while deriving the optimal order. In those standard methods or algorithms “the presence of active nodes indicates that the solution is infeasible”*5, p. 224. But as the method for bipartite graphs presented here produces flows that correspond—at different stages of the preflow method—to the effects of a permutation, excess flows are sent back to the source only during the operation that follows the network flow—during the process of deriving the optimal order from the flow.

2.5.3. Flow Operations

Two important operations are applied iteratively until the optimum is achieved. The discharge operation is the main operation performed for all active vertices, it performs push and relabel operations. The discharge operation is performed iteratively for both sides of the graph:
1^{st} for all active loan account vertices (“left” side of bipartite graph)- and
2^{nd} for all security vertices (“right” side of bipartite graph)
The discharge operation is first performed for loan account vertices (as demander vertices according to the invention) and tries to eliminate all excess flows here by pushing the flows to the coll. security vertices (as supply vertices according to the invention). These pushes eventually lead to excess flow at the security vertices.

Now the flow method looks up for the security vertices that have excess flow and register these vertices as active vertices. In the next phase the discharge operation operates on the active security vertices and pushes excess flow back to the loan account vertices (reflow). After a reflow a part of the loan account vertices will have excess flow again: They are activated and again ‘discharged’.

2.5.4. Relabeling

If during a discharge operation the excess flow of a vertex cannot be pushed because there are no (more) admissible edges (s. 2.5.1.4.) that leave an active loan account vertex or that enter an active security vertex, the active vertex is relabeled: The label of this vertex is then updated to: 1+ the smallest label of all vertices (except source and sink) that are “linked” to this vertex by an edge with non zero residual capacity (see FIG. 10).

If the label value of some vertex is greater than the number of all vertices of the network, then a decision has to be made: Let N(G) be the total number of vertices of the network and let N′(G) be the number of vertices with those high label values. If N′G>1/5*N(G) then the labels of all vertices (‘linked’ by edges with a non zero capacity) are reset to their initial value: 2 for loan account vertices, 1 for security vertices (“global relabeling”). Otherwise if N′G≦1/5*N(G), then the vertex with such high label value is set ‘not active’.

2.5.5. The Flow Method: Technical Description

This description of the flow method is based on the preceding definitions and descriptions of important operations (especially 2.5.1.2, 2.5.1.4, and 2.5.3).

2.5.5.1. Preparing The Network Flow

Before the flow method starts working the system prepares the network:
initial labeling: the labels are set to the distance of the vertices from the sink. As this flow method will never push a flow back to the source (see 2.5.5.2. and note *5) the source vertex is not labeled. The labels of all loan account vertices are set to 2, the labels of the security vertices are set to 1.
initial flows are pushed from the source vertex to the loan account vertices according to the capacity of the edges. All loan account vertices (that now have excess flow) are set active and registered in the activation table for loan account vertices (pointers are set on both sides). The values of the excess flows at the the loan account vertices are—at this stage—the flow that has been pushed from the source vertex. These excess flows are entered in the corresponding attribute of the activation table.
Now the min s-t-cut is ascertained (see 2.5.)
   2.5.5.2. The Flow Method: Termination Criterion

The flow method operates until the flow that has reached the sink corresponds to the value ascertained by the min s-t-cut (see 2.5.5.2.). But as an abridged method of ‘s-t-cut of minimum capacity’ has been applied there are rare cases where the s-t-cut of minimum capacity has not been found so that the s-t-cut value might be greater than the value of the optimal flow. In these rare cases other conditions would terminate the flow: The flow method will also end if either there is no more active vertex (That is exactly the criterion for standard preflow-push methods. But with this method that would only happen (during the course of the flow method) if no credit remains unsecured.), or if the number of total iterations has reached a value that is defined by:

[number of loan account->security edges with non zero capacity]: 4 (experience has shown that in the most complicated cases the optimum has been reached with no more than ⅕ of this value), =max. total iterations, with a lower limit of 10. So the network flow method operates iteratively until
1^{st} condition: the flow to the sink vertex=min s-t-cut value or
2^{nd} condition: there is no more active vertex or
3^{rd} condition: the number of iterations has reached the maximum value (see above def.).
   2.5.5.3. Preflow-Push Method: Iterative Operation

The network flow operations are repeated iteratively, first for all active loan account vertices (vertices with excess flow), pushing excess flow along the edges to security vertices, then for all active security vertices (to operate the reflow of the excess flow at security vertices), then the process is repeated for the now active loan account vertices ( . . . etc.). The flow method operates the following actions as iterative operation until the conditions for termination explained in 2.5.5.2. are met:
1^{st} repeated discharge operation for all active loan account vertices (as preferred demander vertices according to the invention): see 2.5.5.3.1.
2^{nd} registration in activation table for security vertices (as preferred supply vertices according to the invention):
   all security vertices “receiving” a first time non zero flow (a flow pushed along an edge from some loan account vertex) are registered in the activation table for security vertices (pointers are set on both sides). The vertices are set ‘not active’ by default.
3^{rd} push from security vertices to the sink:
   excess flow from security vertices is pushed to the sink along all edges with a non zero residual capacity
4^{th} activation of security vertices (for reflow):
   all collateral security vertices with excess flow (because inflows to some security vertex were greater than the capacity of the edge of this vertex to the sink) are set active. The excess flow of each vertex is updated in the corresponding row of the activation table.
5^{th} repeated discharge operation for all active security vertices (reflow): see 2.5.5.3.2.
6^{th} activation of loan account vertices:
   all loan account vertices with excess flow (after the reflow from coll. security vertices) are set active and the excess flow is updated in the corresponding row of the activation table
      2.5.3.3.1. Discharge Operation For all Active Loan Account Vertices

The discharge operation is repeated iteratively for all active loan account vertices until there are no more active loan vertices. The discharge operation would also end if the operation has been performed for all active loan account vertices without any push of excess flow to the security vertices (only relabeling has been done)—under the additional condition that all vertices have already been relabeled, i.e. when the smallest value of all labels of active loan accounts is greater than the highest label of all those security vertices that are linked to the active loan vertices by edges with a non zero residual capacity.
iteration: discharge for active loan account vertices (as preferred demander vertices according to the invention), repeated until no more vertex is active or no push can be performed after each active vertex has been relabeled
   operation repeated for every (still) active loan account vertex:
      for every active loan account vertex the method performs the following actions at each edge leaving the current vertex and leading to a collateral security vertex in order to push excess flow:
         it selects a next edge with non zero residual capacity leading to a security vertex,
         respecting a special order of selection:
         see 2.5.5.3.1.1. push: special constraint on selection of edges
         if the edge is admissible (s. 2.5.1.4.), then excess flow is pushed according to the
         free capacity of this edge: see 2.5.5.3.1.2.
         if there are no (more) admissible edges and if there is still excess flow the vertex is relabeled (s. 2.5.4. relabeling)
            2.5.5.3.1.1. Special Constraint on Selection of Edges for Push from Loan Account Vertex

Special rules are defined for the selection of admissible edges from loan account vertices to security vertices:

If the excess flow to be pushed from an active loan account vertex is greater than the residual capacity of some current edge e —where residual capacity of an edge e defined as: u(e)−f(e), edge e ε E(G), (f)=flow that has already been pushed along this edge)—

and if there is another admissible edge leaving this vertex with a residual capacity≧excess flow, then the flow will be pushed along the edge with sufficient residual capacity. i.e.:

Let ex_{f}(v) be the excess flow of vertex v,

If ex_{f}(v)>(u(e)−f(e)) for an edge e ε E(G) then an edge e′ ε E(G) leaving the vertex v has priority, if ex_{f}(v)≦(u(e′)−f(e′))

2.5.5.3.1.2. Push Operation: Loan Account Vertices->Security Vertices

Let v be the the active loan account vertex, let e be the current admissible edge that leaves v and enters a security vertex w, let ex_{f}(v) be the excess flow of vertex v, let u(e) be the capacity on edge e, let f(e) (f(e)≧0) be the flow that has already been pushed along edge e, let the residual capacity on edge e be u(e)−f(e). Let a:=a+b denote an increase of the value of a by the value of b; then the new total flow on edge e would be
f(e):=f(e)+ex_{f}(v)−max (0; ex_{f}(v)−(u(e)−e)))
i.e. the flow on edge e is to be increased by the excess flow of v if ex_{f}(v)≦(u(e)−f(e)), otherwise f(e) is to be set to u(e).

In the push operation the method: has to increase the flow on edge e and to decrease the excess flow of vertex v:
If ex_{f}(v)>(u(e)−f(e)) then
   1. ex_{f}(v):=ex_{f}(v)−u(e)+1(e)
   2. f(e):=u(e)
else
   1. f(e):=f(e)+ex_{f}(v)
   2. ex_{f}(v):=0
   3. vertex v is set not active
      2.5.5.3.2 Discharge Operation For all Active Security Vertices (Reflow)

A flow on an edge of a directed graph is always considered in the direction that has been defined for the graph. Each flow must be non negative: f(e)≧0 for all e ε E(G). For this reason the amount of reflow at each edge can never be greater than the amount of the flow that had been pushed at this edge. In this method a reflow is always a flow from a security vertex back to a loan account vertex. Let f⁻(e) be the reflow on edge e. Then
f⁻(e)<0 and f⁻(e)≧f(e)*−1

The discharge operation for active security vertices has to “push back” the excess flow at these vertices according to the “existing” flows on the edges entering these vertices (leaving the loan account vertices):

The discharge operation is repeated iteratively for all active security vertices until there are no more active security vertices. The discharge operation would also end if the operation has been performed for all active security vertices without any push of excess flow (as reflow) to the loan account vertices (only relabeling has been done)—under the additional condition that all vertices have already been relabeled, i.e. when the smallest value of all labels of active security vertices is greater than the highest label of all those loan account vertices that are linked to the security vertices by edges with a non zero flow.
iteration: discharge for active security vertices (as Preferred supply vertices according to the invention), repeated until no more vertex is active or no push can be performed after each active vertex has been relabeled
   operation repeated for every (still) active security vertex:
      for every active security vertex the method performs the following actions at each edge that enters the current vertex (leaving a loan account vertex)—in order to push “back” excess flow:
      it selects a next edge with non zero flow for a push back to a loan account vertex,
      a respecting a special order of selection:
      see 2.5.5.3.2.1 push: special constraint on selection of edges
      if the edge is admissible (s. 2.5.1.4), then excess flow is pushed “back” according
      to the flow of this edge: see 3.2.2 push operation.
      if there are no (more) admissible edges and if there is still excess flow, the vertex is relabeled (s. 2.5.4. relabeling)
         2.5.5.3.2.1 Special Constraint on Selection of Edges for Reflow from a Security Vertex

Special rules are defined for the selection of admissible edges for the reflow from security vertices to loan account vertices:

1^{st} a flow on an edge leaving a loan account vertex that has no other edge leaving this loan account vertex and leading to another security vertex (i.e. the loan account is assigned to only one collateral security) is never pushed back.

2^{nd} If the the flow t(e) of the current edge e (that is the flow that had been pushed along this edge from the loan account vertex) is equal to the capacity of the edge, i.e.

for a security vertex v and an admissible edge e ε δ⁻ (v),

if f(e)=u(e)
   then—under the following conditions—other edges e′ ε δ⁻ (v) would have priority:

(*1) If there is another admissible edge e′ from some loan account vertex to the security vertex v where f(e′)<u(e′) and f(e′)≧ex_{f}(v) then the excess flow of vertex v would be pushed (“back”) along this edge.

(*2) If there are other admissible edges to this security vertex where for each edge e′
f(e′)<u(e′)
and where

$${\sum }_{{e}^{′} ∈ {δ}^{-} ( v )} f ( {e}^{′} ) \geq {ex}_{f} ( v )$$

then the excess flow would be pushed (“back”) along these edges (from the current active security vertex v)
2.5.5.3.2.2 Push Operation: Security Vertices->Loan Account Vertices (Reflow)

Let v be the the active security vertex, let e be the current edge that leaves a loan account vertex v′ and enters v, let ex_{f}(v) be the excess flow of the security vertex v; and let f(e) (f(e)>0) be the flow that had been pushed from v′ along edge e.

The push operation will then decrease the flow on edge e (or “increase by a negative flow”) and it will decrease the excess flow of vertex v accordingly:
If ex_{f}(v)>f(e) then
   1. ex_{f}(v):=ex_{f}(v)−(e)
   2. f(e):=0
else
   1. f(e):=1(e)−ex_{f}(v)
   2. ex_{f}(v):=0
   3. vertex v is set not active
      2.6. Deriving the Optimal Order from the Values of the Network Flow (Technical Description)

The system derives the optimal order of assignments by offsetting the securities against the loan accounts (i.e. assigning supplies to demanders according to the invention) corresponding to the values of the network flow.

Let e be a current edge from a loan account vertex (as a preferred demander vertex according to the invention) to a security vertex (as a preferred supply or resource vertex according to the invention) and let f(e) be the flow on this edge. Let e′ be the edge from the source vertex to the current loan account vertex and let e″ be the edge from the current security vertex to the sink. Let f(e′) be the network flow of edge e′, let f′(e′)=f(e′)−f(e)=the reduced flow on e′ after a security has been offset against a loan account vertex at edge e, let f (e″) be the network flow of edge e″. Let V be the current security vertex, let U (e″) be the security value (capacity of edge v->sink) and let U′ (e″) be the “rest” of the security value after it has been offset against a loan account.

First f′(e′):=f(e′) for all edges from the source to the loan account vertices and U′(e″):=U (e″) for all security vertices

The order of assignments will be determined:
All edges (assignments) with flows that meet the following conditions:
   f(e)=u(e) (i.e. flow=capacity of the edge)—and
   f(e)=f(e′), (i.e. the amount of credit of a single loan account is offset against only one single security)
For each edge that meet these conditions the assignment is set to the next position and the amount of credit of the loan account is offset against the security, i.e.
   f′(e′):=f′(e′)−f(e)
   U′(e″):=U′(e″)−f(e)
All edges (assignments) with flows that meet the following conditions:
   f(e)=u(e) (i.e. flow=capacity of the edge) and
   (f(e)=U′(e″)=f(e″) or
   f(e)>U′(e″) and ex_{f}(v)≧f(e)−U′(e″))
For each edge that meet these conditions the assignment is set to the next position. If there has been excess flow, the excess flow is sent back to the source. Then the amount of credit of the loan account is offset against the security, i.e.
   f′(e′):=f′(e′)−(f(e)−ex_{f}(v))
   U′(e″) U′(e″)−f(e)

In this way an iteration operates on all loan account->security edges, first on all those with flows=capacity, then (iteratively) on all other edges where either
1. f(e)=f′(e′), i.e. flow on e=the not yet offset part of credit of a loan account or
2. f(e)=U′(e″), i.e. flow on e=the not yet offset part of the security value
3. then again back (1., 2.) until the order of all assignments has been determined.
   3. Network Preflow: Example

With a small network I will demonstrate here the way the preflow method operates.

The following figures show
the capacities of the edges by the black numbers at the edges,
the flows at the edges (total flow=flows minus reflows) are marked beneath in blue color
the “distance labels” are indicated with ‘D: n’ at the corresponding vertices and
the excess flow is indicated beneath ‘ex: nn’ (red color)
the arrows at the arcs indicate the current flows

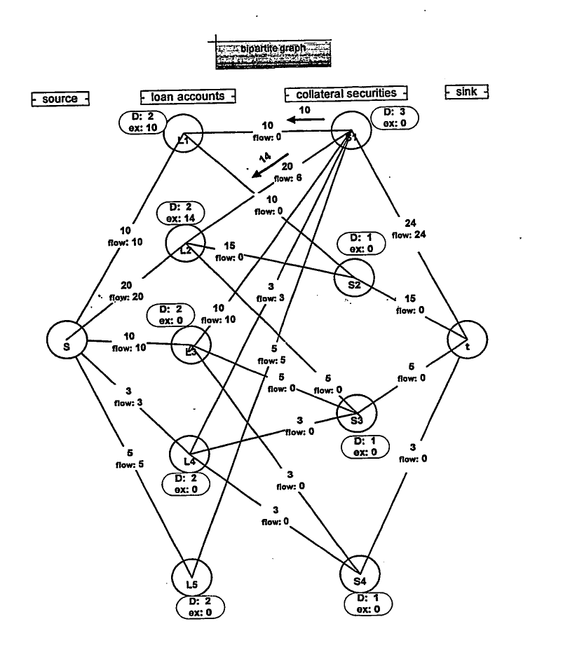

First flows are pushed from the source to the loan account vertices (as preferred demander vertices according to the invention, left side of bipartite graph) according to the capacity of the edges. FIG. 11 shows these flows and the excess flows at the loan account vertices.

After these initial pushes all loan account vertices are active. As all edges to the security vertices (as preferred supply vertices according to the invention) are admissible the excess flows are pushed at the first admissible edge leaving each active loan account vertex—which happen to be the edges to security vertex S1 for all loan account vertices. All these edges have sufficient capacity and no more loan account vertex will be active after these pushes.

As you see in FIG. 12 the capacity of the edge from security vertex S1 to the sink is only 24. Therefore a flow of 24 is pushed to the sink and the excess flow at vertex S1 is (48−24=)24. Vertex S1 will be active now (for reflow).

The reflow discharge operation manages the excess flow at vertex S1. As no admissible edges for the reflow (from loan account vertices to vertex S1) exists, S1 has to be relabeled. The new label of S1 is (2+1=) 3, because all loan account vertices with edges to S1 (edges with “flow that can be pushed back”) have a label value of 2: 2 is the “minimal label value of adjacent vertices” with “reverse capacity”i.e. “flow to push back”.

As FIG. 13 shows a part of the excess flow is pushed back to vertex L1, the other part to vertex L2—according to the “reverse capacities” of these edges. After these reflows from vertex S1 the loan account vertices L1 and L2 have excess flows and are active.

Flows have now to be pushed again from the active loan account vertices to security vertices. The first edge of both active vertices (L1 and L2) is the edge to vertex S1—but this edge is not admissible because the label value of the active vertex (L1 and L2 respectively) should be [label value of the adjacent vertex]+1. In both cases, L1 and L2, the edges to S2 are admissible and the residual capacity is sufficient for the push of all the excess flow of each vertex.

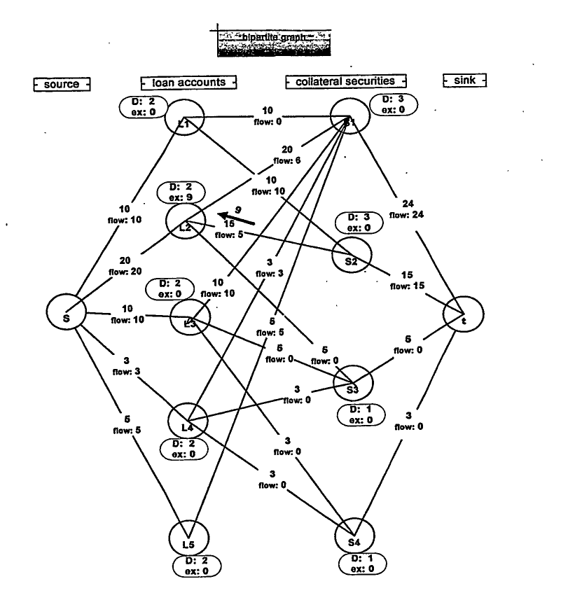

FIG. 14 shows that a flow of 15 can be pushed from vertex S2 to the sink, and that there is now an excess flow of 9 at security vertex S2.

S2 is active now. But the excess flow cannot be pushed back because there is no admissible edge for the reflow.

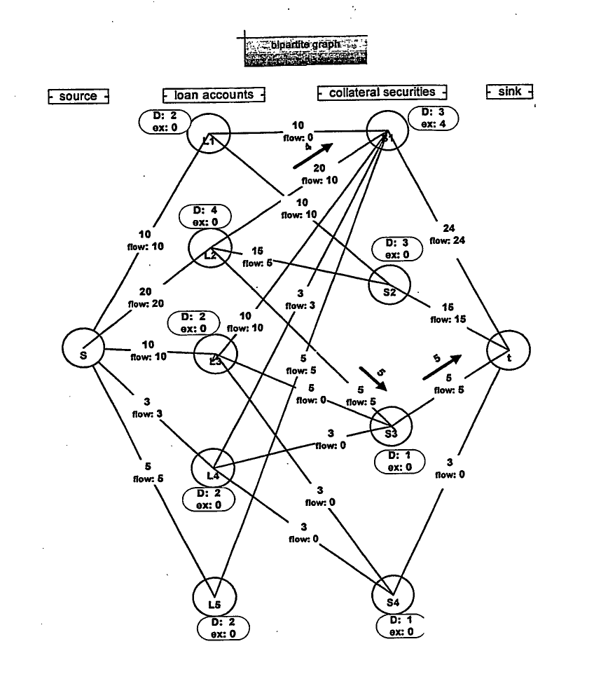

Therefore S2 is relabeled, the new label value of S2 is 3 (see FIG. 15).

After relabeling S2 there are two admissible edges now: the edge from L1 and the edge from L2. The edge from L1 would have been chosen now for the reflow if there were not the special constraint on edge selection. But because of this constraint (see 2.5.5.3.2.1) the excess flow is pushed along the other edge, back to loan account vertex L2 (see FIG. 15).

Loan account vertex L2 has excess flow of value 9 and is active now.

At this moment only the edge leading to S3 is admissible. But according to the (residual) capacity of this edge no more than a flow of 5 can be pushed to S3 (see FIG. 16). So the vertex L2 is still active after this push—with excess flow of value 4. L2 has now to be relabeled because there are no more admissible edges with residual capacity. The new label value of L2 will be 4, and after this relabeling the two edges leading to S1 and S2 would be admissible, but only the edge to S1 has free residual capacity. The remaining excess flow of vertex L2 is pushed to vertex S1—as is shown in FIG. 16.

The security vertex S1 is active now and has excess flow of value 4.

As there is no flow on the edge from L1 to S1, the only admissible edge (with sufficient flow value for the reflow from S1) will be the edge from vertex L3—and so the excess flow of S1 will flow (back) to vertex L3.

In this way the flows will spread across the network until the flow is optimized.

Here ends the example

The first embodiment can be easily converted into a method for optimizing data transfer through a transmission system comprising a number of senders and a number of transmission lines by the substitution of sender for loan account, data rate of the sender for the amount of credit, transmission line for collateral security, and transmission rate for security value. Accordingly, the demanders or demands and the corresponding demand amounts according to the invention are then represented by the senders and their data rates, respectively. Furthermore, the supplies or resources and the corresponding supply amounts according to the invention are represented by the transmission lines and their transmission rates, respectively. The result of the inventive method is, in the present embodiment, an order for assigning the transmission lines to senders (i.e. assigning supplies to demanders) by which the amount of unused transmission rate is minimized, i.e. the data rate of the senders transmitted by the transmission lines is maximized.

The first embodiment can also be converted into a method for optimizing the order of assignment of a number of tasks to be processed to a number of processors or processing capabilities or processing units by the substitution of task for loan account, demand capacity of the task for the amount of credit, processor for collateral security, and processing capacity for security value. Accordingly, the demanders or demands and the corresponding demand amounts according to the invention are then represented by the tasks and their capacity demand, respectively. Furthermore, the supplies or resources and the corresponding supply amounts according to the invention are represented by the processors (or processing capabilities or processing units) and their processing capacity, respectively. The result of the inventive method is, in the present embodiment, an order for assigning the processors (or processing capabilities or processing units) to senders (i.e. assigning supplies to demanders) by which the amount of unused processing capacity is minimized, i.e. the capacity demand of the tasks which is satisfied by the processors (or processing capabilities or processing units) is maximized. The distribution of tasks may, e.g. take place in a multitasking operating system for computers. In this case, the processing units may be units of a single CPU of a computer. In a further example, the tasks may be distributed over a number of CPUs of a computer or computing system for computing in parallel on different CPUs. Such a computing system may comprise a number of CPUs which are distributed over a wide area and which are interconnected e.g. via internet connections.

Accordingly, the method, as well as the inventive device, an embodiment of which will be described next, is usable in a wide rage of technical and commercial fields.

Next, an embodiment of an inventive device for determining an optimized assignment of a number of supplies each having a certain supply amount to a number of demanders each having a certain demand amount will be described with respect to FIG. 17.

The inventive device shown in FIG. 17 comprises a supply input unit 1, a demander input unit 3, and an access input unit 5. The supply input unit 1 is used for inputting data about supplies and their supply amounts. The supplies may, for example, be collateral securities having respective security values as supply amounts, transmission lines offering transmission rates as supply amounts, or processors offering processing capacities as supply amounts. Further, the demander input unit 3 is used for inputting data about demanders and their demand amounts. The demanders may, for example, be loan accounts having certain loan values as demand amounts, senders having certain data rates as demand amounts, or tasks having certain capacity demands as demand amounts. The access input unit 5 is used for inputting, for each demander, access data, i.e. data about which of the supplies are available to satisfy the demand amount of the respective demander. In the present embodiment, all three input units 1, 3, 5 are integrated into a single input device 7.

In addition, the inventive device comprises a network builder 9 as a network construction unit for constructing a network on the basis of the supply data, demander data, and access data. In the network, a supply will be represented by a supply vertex and a demander by a demander vertex. The demander vertices and the supply vertices are connected by edges each providing a certain flow capacity, as described with respect to the inventive method.

The inventive device further comprises a network flow unit 11 which is adapted to determining an optimized network flow distribution through the network built by the network builder 9. The optimized network flow will be represented by flow values through the edges. In addition an assignment unit 13 is present for assigning the supplies to the demanders by assigning the supply vertices to the demander vertices in correspondence to the flow values of the connecting edges. How the assignment will be performed has already been described with respect to the inventive method.

The supply input unit 1, the demander input unit 3, and the access input unit 5 are connected to the network builder 9 for transferring the input data of the input units, i.e. the supply input data, the demander input data, and the access input data, to the network builder 9. The network builder 9 is connected to the network flow unit for transferring, after the network has been built, the data representing the network to the network flow unit 11 which is connected to the assignment unit 13 for transferring, after the optimized network flow has been determined, the data representing the optimized flow.

In the present embodiment, the network builder 9, the network flow unit 11, and the assignment unit 13 are integrated in a single processor unit 15 representing a calculation unit. However, it is also possible to realize these units as independent physical units.

For outputting the optimized assignment, the present embodiment of the inventive device further comprises an output unit 17. The result may, e.g. be outputted on a monitor. Alternatively, the result may be outputted to a control unit, for example a control unit controlling the access of senders to transmission lines, or a control unit for controlling the distribution of tasks over a number of processors, which then controls the respective process on the basis of the optimized assignment.

### REFERENCES

*1 Silvio Turrini; “Optimization in Permutation Spaces”; technical report; DEC Western Research Laboratory; Palo Alto, Calif., USA; 1996
*2 A. V. Goldberg, R. E. Tarjan; “A New Approach to the Maximum Flow Problem”; in Proc. 18^{th} Annual ACM Symposium on Theory of Computing; pp 136-146; 1986
*3 B. V. Cherkassky, A. V. Goldberg; “On Implementing Push-Relabel Method for the Maximum Flow Problem”; Technical report, Stanford University, Computer Science Dep.
*5 R. K. Ahuja, Th. L. Magnanti, J. B. Orlin, “Network Flows”, Prentice Hall 1993
*6 B. Korte, J. Vygen, “Combinatorial Optimization”, Springer Berlin-Heidelberg, 2000

### Combinatorial Methods/Network Flows

1. Introductory:

Eugene Lawler, “Combinatorial Optimization”, Dover Publ., 2001
B. Korte, J. Vygen, “Combinatorial Optimization”, Springer Berlin-Heidelberg, 2000
   2. Fundamental:
R. K. Ahuja, Th. L. Magnanti, J. B. Orlin, “Network Flows”, Prentice Hall 1993
D. S. Johnson, C. C. McGeoch (Hrsg.), “Network Flows and Matching”, DIMACS Series Vol. 12, American Mathematical Society, 1993

1. Method for optimizing the order of assignment of a number of supplies or resources, such as computer processor units, to a number of demanders or demands, such as tasks to be processed by the computer processor units, where each supply or resource has a certain supply or resource amount, such as a processing capacity, and each demander has a certain demand amount which is to be satisfied by said supplies or resources, such as a capacity demand, i.e. the processing capacity necessary to process the task, the method comprising the steps of:
building a network,
in which the supplies are represented by supply vertices connected to a sink vertex via sink edges of a flow capacity which represents the supply amount of the respective supply, the sink vertex being sink of a network flow;
in which the demanders are represented by demander vertices connected to a source vertex via source edges of a flow capacity which represents the demand amount of the respective demander, the source vertex being source of a network flow; and
in which supply vertices and demander vertices are connected by edges of certain flow capacities;
determining an optimized network flow distribution of flow values through the edges by an iterative flow-method; and
deriving the optimized order of assignment from the optimized network flow distribution by assigning the supply vertices to the demander vertices in correspondence to the flow values of the connecting edges.

2-7. (canceled)

8. Method according to claim 1, wherein the certain flow capacity of an edge connecting a demander vertex to a supply vertex is given by the smaller one of the capacity of the respective source edge and the capacity of the respective sink edge.

9. Method according to claim 8, wherein the assigning operation, in a first stage, assigns a supply vertex to a demander vertex only if these vertices are connected by an edge for which the flow value equals the capacity.

10. Method according to claim 9, wherein the assigning operation first assigns supply vertices to such demander vertices which are connected to the respective supply vertex by an edge for which the flow value equals the flow value of the corresponding source edge before it assigns supply vertices to such demander vertices which are connected to the respective supply vertex by an edge for which the flow value is equal to or higher than a remaining flow value of the corresponding sink edge which has not yet been assigned to a demander vertex.

11. Method according to claim 10, wherein the first stage is performed until all supply vertices and demander vertices which are connected by edges for which the flow value equals the capacity are assigned.

12. Method according to claim 11, wherein the assigning operation, in a second stage, assigns a supply vertex to a demander vertex if the flow value of the connecting edge corresponds to the flow value of the corresponding source edge reduced by a fraction of its demand amount already assigned to a supply vertex, or to the flow value of the corresponding sink edge reduced by a fraction of its supply amount already assigned to a demander vertex.

13. Method according to claim 12, wherein the assigning operation, in the second stage, first assigns such supply vertices to demander vertices for which the flow value of the connecting edge corresponds to the flow value of the corresponding source edge reduced by a fraction of its demand amount which is already assigned to a supply vertex.

14. Method according to claim 1, wherein the certain flow capacity of an edge connecting a demander vertex to a supply vertex is given by the smaller one of the capacity of the respective source edge and the capacity of the respective sink edge.

15. Method for balancing a number of loan accounts with a number of collateral securities, where each loan account has a certain loan value and each collateral security has a certain security value and wherein the collateral securities are to be offset against the loan accounts, the method comprising the steps of:
building a network
in which the collateral securities are represented by security vertices connected to a sink vertex via sink edges of a flow capacity which represents the security value of the respective collateral security, the sink vertex being sink of a network flow;
in which the loan accounts are represented by loan vertices connected to a source vertex via source edges of a flow capacity which represents the loan value of the respective loan account, the source vertex being source of a network flow; and
in which security vertices and loan vertices are connected by edges of certain flow capacities;
determining an optimized network flow distribution of flow values through the edges by an iterative flow-method; and
deriving the optimized order of assignment from the optimized network flow distribution by offsetting the security vertices against the loan vertices in correspondence to the flow values of the connecting edges.

16-18. (canceled)

19. Method according to claim 15, comprising discharge operations pushing flows from loan vertices to security vertices and discharge operations pushing flows from security vertices to loan vertices.

20. Method according to claim 19, wherein the discharge operation is performed iteratively for loan vertices and security vertices.

21. (canceled)

22. Method according to claim 15, wherein offsetting the security vertices against the loan vertices is performed by an iterative offsetting operation.

23. Method according to claim 22, wherein the offsetting operation in a first stage offsets a security vertex against a loan vertex only if these vertices are connected by an edge for which the flow value equals the capacity.

24. Method according to claim 23, wherein the offsetting operation first offsets security vertices against such loan vertices which are connected to the respective security vertex by an edge for which the flow value equals the flow value of the corresponding source edge before it offsets security vertices against such loan vertices which are connected to the respective security vertex by an edge for which the flow value is equal to or higher than a remaining flow value of the corresponding sink edge which has not yet been offset against to a loan vertex.

25. Method according to claim 24, wherein the first stage is performed until all security vertices and loan vertices which are connected by edges for which the flow value equals the capacity are offset.

26. Method according to claim 25, wherein the offsetting operation, in a second stage, offsets a security vertex against al loan vertex if the flow value of the edge connecting the respective vertices corresponds to the flow value of the corresponding source edge reduced by a fraction of its loan value already offset against a security vertex, or to the flow value of the corresponding sink edge reduced by a fraction of its security value already offset against a loan vertex.

27. Method according to claim 26, wherein the offsetting operation, in the second stage, first offsets such security vertices against loan vertices for which the flow value of the edge connecting the respective vertices corresponds to the flow value of the corresponding source edge reduced by the loan value already offset against a collateral security.

28. Method according to any of the claims 15 to 27, wherein the certain flow capacity of an edge connecting a loan vertex to a sink vertex is given by the smaller one of the capacity of the respective source edge and the capacity of the respective sink edge.

29. Method for optimizing the data transfer through a transmission system comprising a number of senders and a number of transmission lines, where each transmission line has a certain transmission rate and each sender is connected to a number of said transmission lines and has a certain data rate, by assigning transmission lines to senders, the method comprising the steps of:
building a network
in which the transmission lines are represented by transmission vertices connected to a sink vertex via sink edges of a flow capacity which represents the transmission rate of the respective transmission line, the sink vertex being sink of a network flow;
in which the senders are represented by sender vertices connected to a source vertex via source edges of a flow capacity which represents the data rate of the respective sender, the source vertex being source of a network flow; and
in which transmission vertices and sender vertices are connected by edges of certain flow capacities;
determining an optimized network flow distribution of flow values through the edges by an iterative flow-method; and
deriving the optimized order of assignment from the optimized network flow distribution by assigning the transmission vertices to the sender vertices in correspondence to the flow values of the connecting edges.

30. Method according to claim 29, wherein in the iterative flow-method comprises a discharge operation pushing a flow from an active vertex at which the sum of the incoming network flow is higher than the sum of the outgoing network flow along an admissible edge, where the admissibility of an edge is defined by a label of the vertex connected to the active vertex by the respective edge.

31. Method according to claim 30, further comprising a relabeling operation changing the label of the active vertex if there is no admissible edge along which the discharge operation can be performed.

32. Method according to claim 31, wherein, when the label of the vertex to be discharged is Ψ(v) and the label of a vertex connected by an edge is Ψ(w), said edge being admissible if Ψ(v)=Ψ(w)+1, and wherein the label Ψ(v) of the vertex to be discharged is increased by one in the relabeling operation.

33. Method according to claim 32, comprising discharge operations pushing flows from sender vertices to transmission vertices and discharge operations pushing flows from transmission vertices to sender vertices.

34. Method according to claim 33, wherein the discharge operation is performed iteratively for sender vertices and transmission vertices.

35. Method according to any of the claims 29 to 34, wherein a total flow is the network flow through the edges from the source vertex to the sink vertex and the flow-method comprises the steps of:
determining an upper limit of the highest possible total flow through the edges; and
iteratively distributing the network flow through the edges until at least one of the conditions is fulfilled:
i) the network flow corresponds to the upper limit of the highest possible total flow,
ii) the sum of the incoming network flow at a vertex equals the sum of the outgoing network flow of said vertex for each transmission vertex and for each sender vertex,
iii) the number of iterations has reached a given maximum value.

36. Method according to claim 29, wherein assigning the transmission vertices to the sender vertices is performed by an iterative assigning operation.

37. Method according to claim 36, wherein the assigning operation, in a first stage, assigns a transmission vertex to a sender vertex only if these vertices are connected by an edge for which the flow value equals the capacity.

38. Method according to claim 37, wherein the assigning operation first assigns transmission vertices to such sender vertices which are connected to the respective transmission vertex by an edge for which the flow value equals the flow value of the corresponding source edge before it assigns transmission vertices to such sender vertices which are connected to the respective supply vertex by an edge for which the flow value is equal to or higher than a remaining flow value of the corresponding sink edge which has not yet been assigned to a sender vertex.

39. Method according to claim 38, wherein the first stage is performed until all transmission vertices and sender vertices which are connected by edges for which the flow value equals the capacity are assigned.

40. Method according to claim 39, wherein the assigning operation, in a second stage, assigns a transmission vertex to a sender vertex if the flow value of the connecting edge corresponds to the flow value of the corresponding source edge reduced by a fraction of its data rate already assigned to a transmission vertex, or to the flow value of the corresponding sink edge reduced by a fraction of its transmission rate already assigned to a sender vertex.

41. Method according to claim 40, wherein the assigning operation, in the second stage, first assigns such transmission vertices to sender vertices for which the flow value of the connecting edge corresponds to the flow value of the corresponding source edge reduced by a fraction of its data rate already assigned to a transmission vertex.

42. Method according to claim 41, wherein the certain flow capacity of an edge connecting a sender vertex to a transmission vertex is given by the smaller one of the capacity of the respective source edge and the capacity of the respective sink edge.

43. Method for optimizing the order of assignment of a number of tasks to a number of processors, where each processor has a certain processor capacity and each task has a certain capacity demand which is to be satisfied by at least one of said processors, the method comprising the steps of:
building a network
in which the processors are represented by processor vertices connected to a sink vertex via sink edges of a flow capacity which represents the processor capacity of the respective processor, the sink vertex being sink of a network flow;
in which the tasks are represented by task vertices connected to a source vertex via source edges of a flow capacity which represents the capacity demand of the respective task, the source vertex being source of a network flow; and
in which processor vertices and task vertices are connected by edges of certain flow capacities;
determining an optimized network flow distribution of flow values through the edges by an iterative flow-method; and
deriving the optimized order of assignment from the optimized network flow distribution by assigning the processor vertices to the task vertices in correspondence to the flow values of the connecting edges.

44. Method according to claim 43, wherein in the iterative flow-method comprises a discharge operation pushing a flow from an active vertex at which the sum of the incoming network flow is higher than the sum of the outgoing network flow along an admissible edge, where the admissibility of an edge is defined by a label of the vertex connected to the active vertex by the respective edge.

45. Method according to claim 44, further comprising a relabeling operation changing the label of the active vertex if there is no admissible edge along which the discharge operation can be performed.

46. Method according to claim 45, wherein, when the label of the vertex to be discharged is Ψ(v) and the label of a vertex connected by an edge is Ψ(w), said edge being admissible if Ψ(v)=Ψ(w)+1, and wherein the label Ψ(v) of the vertex to be discharged is increased by one in the relabeling operation.

47. Method according to claim 46, comprising discharge operations pushing flows from task vertices to processor vertices and discharge operations pushing flows from processor vertices to task vertices.

48. Method according to claim 47, wherein the discharge operation is performed iteratively for task vertices and processor vertices.

49. Method according to claim 43, wherein a total flow is the network flow through the edges from the source vertex to the sink vertex and the flow-method comprises the steps of:
determining an upper limit of the highest possible total flow through the edges; and
iteratively distributing the network flow through the edges until at least one of the conditions is fulfilled:
i) the network flow corresponds to the upper limit of the highest possible total flow,
ii) the sum of the incoming network flow at a vertex equals the sum of the outgoing network flow of said vertex for each processor vertex and for each task vertex,
iii) the number of iterations has reached a given maximum value.

50. Method according to claim 49, wherein assigning the processor vertices to the task vertices is performed by an iterative assigning operation.

51. Method according to claim 50, wherein the assigning operation, in a first stage, assigns a processor vertex to a task vertex only if these vertices are connected by an edge for which the flow value equals the capacity.

52. Method according to claim 51, wherein the assigning operation first assigns processor vertices to such task vertices which are connected to the respective processor vertex by an edge for which the flow value equals the flow value of the corresponding source edge before it assigns processor vertices to such task vertices which are connected to the respective processor vertex by an edge for which the flow value is equal to or higher than a remaining flow value of the corresponding sink edge which has not yet been assigned to a task vertex.

53. Method according to claim 52, wherein the first stage is performed until all processor vertices and task vertices which are connected by edges for which the flow value equals the capacity are assigned.

54. Method according to claim 53, wherein the assigning operation, in a second stage, assigns a processor vertex to a task vertex if the flow value of the connecting edge corresponds to the flow value of the corresponding source edge reduced by a fraction of its capacity demand already assigned to a processor vertex, or to the flow value of the corresponding sink edge reduced by a fraction of its processing capacity already assigned to a task vertex.

55. Method according to claim 54, wherein the assigning operation in the second stage first assigns such processor vertices to task vertices for which the flow value of the connecting edge corresponds to the flow value of the corresponding source edge reduced by a fraction of its capacity demand which is already assigned to a processor vertex.

56. Method according to claim 43, wherein the certain flow capacity of an edge connecting a task vertex to a processor vertex is given by the smaller one of the capacity of the respective source edge and the capacity of the respective sink edge.

57. Device for determining an optimized assignment of a number of supplies or resources, such as computer processor units, each having a certain supply or resource amount, such as a processing capacity, to a number of demanders or demands, such as tasks to be processed by the computer processor units, each having a certain demand amount to be satisfied by said supplies, such as a capacity demand, i.e. a processing capacity necessary to process the task, in which, after the assignment, the sum of unsatisfied demand amounts is minimized, comprising:
a supply input unit for inputting supply data representing supplies and their supply amounts;
a demander input unit for inputting demander data representing demanders and their demand amounts,
an access input unit for inputting access data representing, for each demander, the corresponding supplies which can be accessed by the respective demander for satisfying its demand amount;
a network construction unit for constructing, on the basis of the supply data, the demander data and the access data, a network comprising:
a) a supply vertex for each supply,
b) a demander vertex for each demander,
c) a sink vertex,
d) a source vertex,
e) edges, each having a certain flow capacity and connecting a supply vertex and a demander vertex,
f) sink edges, each connecting the sink vertex to one of the supply vertices and having a flow capacity representing the supply amount of the respective supply, and
g) source edges, each connecting the source vertex to one of the demander vertices and having a flow capacity representing the demand amount of the respective demander;
a network flow unit for determining an optimized network flow distribution through the network, the optimized network flow being represented by flow values through the edges; and
an assignment unit for assigning the supplies to the demanders by assigning the supply vertices to the demander vertices in correspondence to the flow values of the connecting edges.

58. Device according to claim 57, wherein the input units are formed by a single input unit.

59. Device according to claim 57, wherein the input units are integrated into a single device.

60. Device according to claim 59, wherein the network construction unit, the network flow unit, and the assignment unit are realized by a single calculator unit.

61. Device for balancing a number of loan accounts with a number of collateral securities, where each loan account has a certain loan value and each collateral security has a certain security value and wherein the collateral securities are to be offset against the loan accounts, comprising:
a security input unit for inputting security data representing collateral securities and their security values;
a loan input unit for inputting loan data representing loan accounts and their loan values,
an access input unit for inputting access data representing, for each loan account, the corresponding collateral securities, which can be offset against the respective loan account;
a network construction unit for constructing, on the basis of the security data, the loan data and the access data, a network comprising:
a) a security vertex for each security,
b) a loan vertex for each loan,
c) a sink vertex,
d) a source vertex,
e) edges, each having a certain flow capacity and connecting a security vertex and a loan vertex,
f) sink edges, each connecting the sink vertex to one of the security vertices and having a flow capacity representing the security value of the respective collateral security, and
g) source edges, each connecting the source vertex to one of the loan vertices and having a flow capacity representing the loan value of the respective loan account;
a network flow unit for determining an optimized network flow distribution through the network, the optimized network flow being represented by flow values through the edges; and
an assignment unit for offsetting the collateral securities against the loan accounts by assigning the security vertices to the loan vertices in correspondence to the flow values of the connecting edges.

62. Device according to claim 61, wherein the input units are formed by a single input unit.

63. Device according to claim 61, wherein the input units are integrated into a single device.

64. Device according to claim 61, wherein the network construction unit, the network flow unit, and the assignment unit are realized by a single calculator unit.

65. Device for determining an optimized data transfer through a transmission system comprising a number of senders and a number of transmission lines by assigning transmission lines to senders, where each transmission line has a certain transmission rate and each sender is connected to a number of said transmission lines and has a certain data rate, comprising:
a transmission line input unit for inputting transmission line data representing transmission lines and their transmission rates,
a sender input unit for inputting sender data representing senders and their data rates,
an access input unit for inputting access data representing, for each sender, the corresponding transmission lines, which can be accessed by a sender for transferring data;
a network construction unit for constructing, on the basis of the transmission line data, the sender data and the access data, a network comprising:
a) a transmission vertex for each transmission line,
b) a sender vertex for each sender,
c) a sink vertex,
d) a source vertex,
e) edges, each having a certain flow capacity and connecting a transmission vertex and a sender vertex,
f) sink edges, each connecting the sink vertex to one of the transmission vertices and having a flow capacity representing the transmission rate of the respective transmission line, and
g) source edges, each connecting the source vertex to one of the sender vertices and having a flow capacity representing the data rate of the respective sender;
a network flow unit for determining an optimized network flow distribution through the network, the optimized network flow being represented by flow values through the edges; and
an assignment unit for assigning the transmission lines to the senders by assigning the transmission vertices to the sender vertices in correspondence to the flow values of the connecting edges.

66. Device according to claim 65, wherein the input units are formed by a single input unit.

67. Device according to claim 65, wherein the input units are integrated into a single device.

68. Device according to claim 65, wherein the network construction unit, the network flow unit, and the assignment unit are realized by a single calculator unit.

69-72. (canceled)

73. Computer program product for optimizing the order of assignment of a number of supplies to a number of demanders comprising instructions which, when loaded into a computer, cause said computer to perform a method as claimed in claim 1.

74. Computer program product for balancing a number of loan accounts with a number of collateral securities comprising instructions which, when loaded into a computer, cause said computer to perform a method as claimed in claim 15.

75. Computer program product for optimizing the data transfer through a transmission system comprising a number of senders and a number of transmission lines comprising instructions which, when loaded into a computer, cause said computer to perform a method as claimed in claim 19.

76. Computer program product for optimizing the order of assignment of a number of tasks to a number of processors comprising instructions which, when loaded into a computer, cause said computer to perform the method as claimed in claim 33.

77. Storage medium comprising stored data which represent a computer program product as claimed in claim 73.

78. Storage medium comprising stored data which represent a computer program product as claimed in claim 74.

79. Storage medium comprising stored data which represent a computer program product as claimed in claim 75.

80. Storage medium comprising stored data which represent a computer program product as claimed in claim 76.
